(19) United States
(12) Patent Application Publication
(10) Pub. No.: US 2016/0091889 A1
(43) Pub. Date: Mar. 31, 2016

(54) NUMERICAL CONTROL SYSTEM

(71) Applicant: FANUC Corporation, Yamanashi (JP)

(72) Inventors: Masatoshi NAKAJIMA, Minamitsuru-gun (JP); Koichi MURATA, Minamitsuru-gun (JP); Mamoru KUBO, Minamitsuru-gun (JP); Yusaku YAMADA, Minamitsuru-gun (JP)

(21) Appl. No.: 14/860,924

(22) Filed: Sep. 22, 2015

(30) Foreign Application Priority Data
Sep. 26, 2014 (JP) 2014-196643

(51) Int. Cl. G05B 19/418

(52) U.S. Cl. CPC G05B 19/4185; G05B 2219/50291; G05B 2219/31102

(57) ABSTRACT

A numerical control system for controlling a plurality of machining tools by a host computer connected to the machining tools via communication line, having a host-computer-side numerical control device including a control information generation unit, and a machining-tool-side numerical control device, installed in each machining tool, including a shaft control unit configured to control a shaft of the machining tool based on the control information sent from the host computer and a machining-tool-side network control unit configured to send the feedback information to the host computer.

### BACKGROUND OF THE INVENTION

1. Field of the Invention

The present invention relates to a numerical control system.

2. Description of the Related Art

In a numerical machining tool for controlling machining tools, various kinds of control software, such as CNC control, PMC control, servo control, spindle control, display control, and network control, operate for each machining tool.

In addition to that, the machining tool includes a dedicated hardware for operating the control software.

Japanese Patent Laid-Open No. 08-263125 discloses a technique in which software installed in an industrial robot is updated by a host computer via a network.

However, conventionally, it is necessary to control the machining tool, that all of the software to control, the dedicated hardware, and various kinds of data are installed in the numerical control device of the machining tool. The various kinds of data includes NC program, NC parameter, various kinds of correction data such as offset data of a tool, ladder program, PMC parameter, machine adjustment data. Therefore, it is necessary for an operator to go to each machining tool to update the control software when new function is added or malfunction is found in the control software.

The host computer may store the software for updating, but it is necessary for the operator to go to the industrial robot to manipulate each industrial robot for updating the software, in the technique disclosed Japanese Patent Laid-Open No. 08-263125.

In addition to that, the hardware, which is dedicated to the machining tool, is installed to each machining tool, so it is necessary for the operator to work for each machining tool, for exchange of the hardware for control.

### SUMMARY OF THE INVENTION

In view of the above-described problems in the prior art techniques, a purpose of the present invention is to provide a numerical control device which enables to reduce the maintenance cost of the machining tool.

A numerical control device according to the present invention is the numerical control device for controlling a plurality of Machining tools by a host computer connected to the machining tools via communication line, having a host-computer-side numerical control device installed in the host computer and a machining-tool-side numerical control device installed in each machining tool, the host-computer-side numerical control device including a storage unit configured to store shared data for controlling the plurality of machining tools and machine unique data, a control information generation unit configured to generate control information for controlling the plurality of machining tools, and a host-computer-side network control unit configured to send the control information to the plurality of machining tools via the communication line and receive feedback information from the plurality of machining tools, and the machining-tool-side numerical control device including a shaft control unit configured to control a shaft of the machining tool based on the control information sent from the host computer, a feedback information generation unit configured to generate the feedback information based on shaft control of the machining tool, and a machining-tool-side network control unit configured to receive the control information from the host computer and send the feedback information to the host computer.

The host-computer-side numerical control device may store control software in a memory of the host-computer-side numerical control device, the host-computer-side numerical control device may include a CNC control unit configured to generate pulse information to be included in the control information used for controlling the plurality of shafts of the machining tool, a PMC control unit configured to generate machine input control signal used for the shaft control of the machining tool to be controlled, and a display control unit configured to generate screen input display information used for displaying on a screen, and the CNC control unit, the PMC control unit, the display control unit, the host-computer-side network control unit may be composed by the control software and a hardware installed in the host-computer-side numerical control device.

The machining-tool-side numerical control device may further include a display unit configured to screen input display information in the control information sent from the host computer, and an input device for manipulating the machining tool; wherein the shaft control unit, and the shaft control unit may be configured to control the shaft of the machining tool based on the pulse information in the control information and the machine input control signal and generate machine output control signal, machine output control information, and screen output display signal based on information generated by control of the machining tool and information from the input device.

The host-computer-tool-side numerical control device may generate the control information for controlling the plurality of machining tools based on the feedback information and the shared data and the machine unique data, sent from the plurality of machining tools.

The machining-tool-side numerical control device may further comprise a countermeasure buffer against delay, and the shaft control unit controls the machining tool based on the control information stored in the countermeasure buffer against delay.

Hereinafter, the host computers in network may be collectively referred to as a “cloud”.

The present invention, with the above mentioned configuration, executes software for CNC control, for PMC control, and for display control in the hardware on cloud side capable of controlling the plurality of machining tools and eliminates the need for these control software and the dedicated hardware to be installed in the machining tool side numerical control device.

It becomes possible to update the control software of all machining tool connected to the cloud only by updating the control software operating on cloud side while eliminating the need for the dedicated hardware to be installed in the machining tool, so the cost will be reduced as the number of the connected machining tool is increased while only it become possible to always operate the machining tool with the latest hardware only by exchanging the hardware on cloud side to be the latest one.

In addition to that, it is possible to manage, on the cloud, whole of the NC program and the machine original data necessary for controlling the machining tool, so the plurality of machining tool can share these information and the storage memory which has been needed on machining tool side can be reduced.

The present invention, with the above described configuration, makes it possible to significantly reduce cost for maintenance of the machining tool.

### BRIEF DESCRIPTION OF THE DRAWINGS

The above-described object, the other object, and the feature of the invention will be proved from the description of embodiments below with reference to the accompanying drawings. In these drawings:

FIG. 1 is a schematic block diagram according to an embodiment of the present invention.

FIG. 2 is a flowchart showing control process of the machining tool at cloud side according to an embodiment of the present invention.

FIG. 3 is a flowchart showing control process at machining tool side according to an embodiment of the present invention.

### DETAILED DESCRIPTION OF THE PREFERRED EMBODIMENTS

In the present embodiment, the numerical control device are disposed on cloud side in network and machining tool side. Software for CNC control, PMC control, and display control is executed on the cloud side, while software for servo control and spindle control to operate the machine is executed on the machining tool side. Software for network control on the cloud side and the machining tool side will exchange the data between the both sides.

Machine control information such as pulse information, machine input control signal, and screen input display information, is generated using shared data such as NC program managed on the cloud, NC parameter, various kinds of correction data including tool offset data, ladder program, PMC parameter, and machine unique data. The machine control information sent to the machining tool side.

It is noted that, the cloud may be a high performance host computer or may be implemented by configuring a plurality of host computers as a load distribution management system.

The machining tool receive data sent from the cloud and controls the machine based on the pulse information and the machine input control signal while performing screen display using the screen input display information. From the machining tool side, the feedback information such as the machine output control signal, machine output control information including servo delay amount, and the screen output display information such as manipulation information (key), position feedback data, servo/spindle load current value, are sent to the cloud side. On the cloud side, machine control information including pulse information and machine input control signal is generated using the machine output control signal and machine output control information of the received feedback information of the machine and based on the shared data and the machine unique data, and the screen input display information is generated based on the screen output display information. The generated information and signal are sent to the machine.

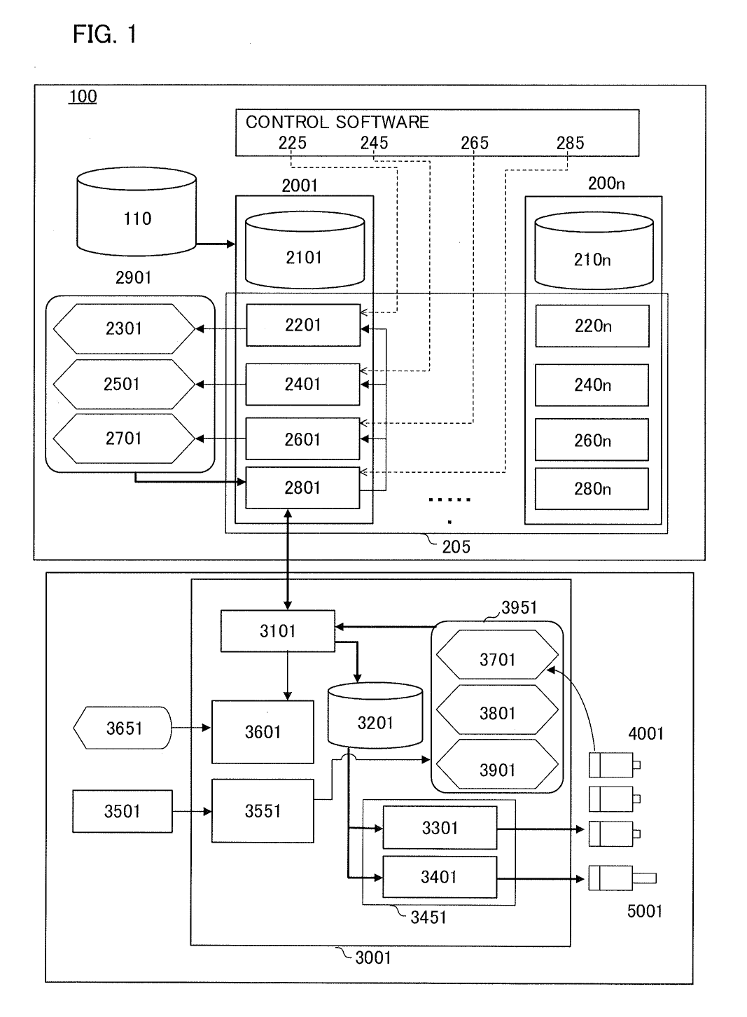

FIG. 1 is a schematic block diagram according to an embodiment of the present invention. In the figure, the machining tools No. 2 to No. 2 are not shown.

In the embodiment, the control unit of the machining tool conventionally set in the numerical control devices 3001 to 300n, installed in the machining tools No. 1 to No. n, is implemented as a hardware (205) on the cloud side numerical control device 100, capable of controlling a plurality of machining tools, as a control unit which is capable of simultaneously controlling the machining tools No. 1 to No. n. Machining tool control unit 2001 to 200n, including CNC control units 2201 to 220n, PMC control units 2401 to 240n, display control units 2601 to 260n, and network control units 2801 to 280n, control each machining tool. Here, 2901 designates the control information generation unit and 3451 designates the shaft control unit.

The shared data and machine unique data, managed by the numerical control devices 3001 to 300n on the machining tool No. 1 to No. n side in the related art, are configured to be managed by the storage memory (shared data 110, machine unique data 2101 to 210n) on the cloud side numerical control device 100.

It is noted that, each control software, that is, one CNC software 225, one PMC software 245, one display software 265, and one network software 285, necessary for the CNC control units 2201 to 220n, the PMC control units 2401 to 240n, the display control units 2601 to 260n, and the network control units 2801 to 280n, operating in the hardware (205) capable of controlling the plurality of machining tools, are installed in the cloud, and configured to operate when the machining tool is activated.

In addition to that, the data exchange between the cloud side numerical control device 100 and the machining tool No. 1 to No. n side numerical control devices is configured to be performed by the network control units installed in each numerical control device.

With the configuration mentioned above, update of the control software (the CNC software 225, the PMC software 245, the display software 265, and the network software 285) for the CNC control unit, the PMC control unit, the display control unit, and the network control unit, which has been necessary for working for each machining tool, becomes possible only by updating the software in the cloud, eliminating the need for the dedicated hardware for control in the numerical control devices 3001 to 300n on the machining tool side No. 1 to No. n.

In addition to that, countermeasure buffers 3201 to 320n against delay for preventing delay and implementing stable operation are set in the numerical control devices 3001 to 300n on the machining tools No. 1 to No. n side, to prevent delay of data transfer velocity in the network and to implement stable operation. The machining tools are configured to be controlled through the countermeasure buffers against delay.

The control process of the machining tool according to an embodiment of the present invention will be described below.

<Starting of the Machining Tool>

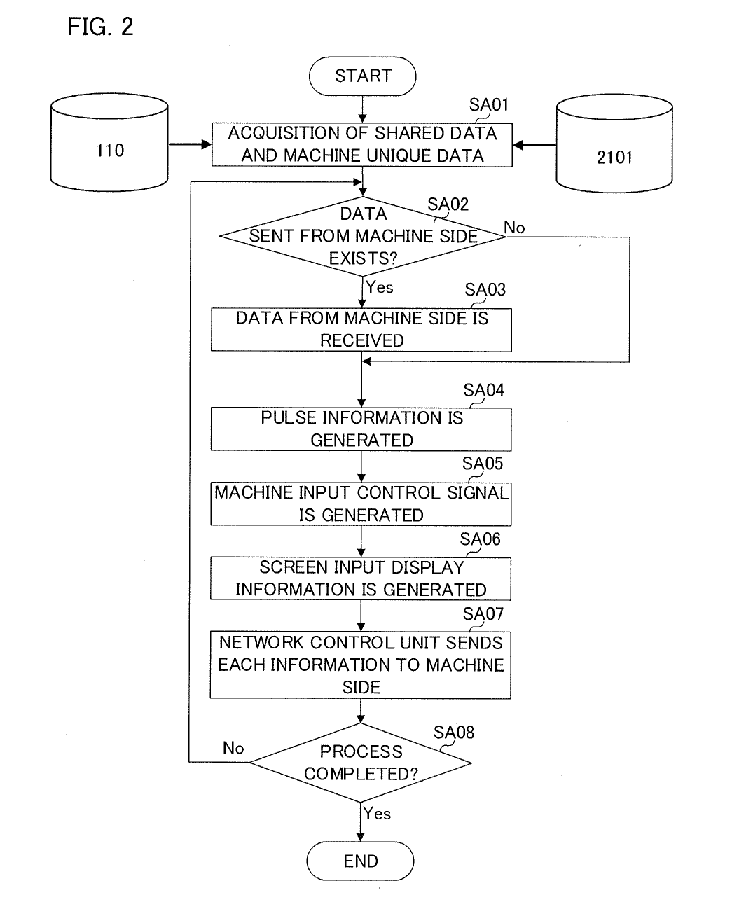

The starting method of the machining tool No. 1 according to the present embodiment will be described with the block diagram in FIG. 1 and the flowchart in FIG. 2.

When the machining tool No. 1 is switched on, the machining tool No. 1 activates the control software for a servo control unit 3301, a spindle control unit 3401, a network control unit 3101 first, a key input controller 3551, a display controller 3601 next, and a numerical control device 3001 on the machining tool No. 1 side last of all.

The numerical control device 100 on the cloud side monitors the starting of the machining tool No. 1, and when the starting is detected, activates the control software (network software 285) for a network control unit 2801, to establish communication with a network control unit 3101. Then the control software (the CNC software 225, the PMC software 245, the display software 265) for the CNC control unit 2201, the PMC control unit 2401, the display control unit 2601, are activated in the hardware capable of controlling a plurality of the machining tools to start the machining tool No. 1 control unit 2001 using the shared data 110 and the machine unique data 2101 (Step SA01). The shared data 110 includes the NC program, the NC parameter, various kinds of correction data including tool offset data, the ladder program, the PMC parameter, and the like, while the machine unique data 2101 includes machine adjustment data and the like.

The cloud side monitors the starting of the machining tool No. 1 in the embodiment. It is noted that, the machining tool No. 1 may notice the cloud of the starting.

<Operation Control Process on the Cloud Side>

The operation control process on the cloud side according to the present embodiment will be described with the block diagram in FIG. 1 and the flowchart in FIG. 2. Here, “3951” designates a feedback information generation unit of the machining tool No. 1, “4001” designates a servo motor, and “5001” designates a spindle motor.

The cloud side numerical control device 100 first checks the existence of the data sent from the machining tool No. 1 side numerical control device 3001 (Step SA02). If the sent data exists, the cloud side numerical control device 100 receives the data (SA03) and the process proceeds to the generation process of the pulse information 2301 (Step SA04). If not, the process SA03 is Skipped since the sent data does not exists, and the process proceeds to the generation process of the pulse information 2301 (Step SA04).

The sent data includes the machine output control signal 3701, the machine output control information 3801 such as servo delay amount, the screen output display information 3901 such as the manipulation information (key), the position feedback data, and the servo/spindle load current value.

The pulse information 2301 for operating the machine is generated based on the received data and the NC program under execution in the generation process of the pulse information 2301 (Step SA04), and the process proceeds to the generation process of the machine input control signal 2501 (Step SA05).

The machine input control signal 2501 for operating the machine based on the received data and the NC program under execution, as in Step SA04, in the generation process of the machine input control signal 2501 (Step SA05), and the process proceeds to the generation process of the screen input display information 2701 (Step 06).

The screen input display information 2701 is generated based on information of the program under execution and the received screen output display information 3901, in the generation process of the screen input display information 2701 (Step 06).

Each kind of the generated information is sent from the network control unit 2801 to the machining tool side (Step SA07).

It is determined that all operation process is completed finally, and the process returns to the checking process (Step SA02) if all process is not completed, while the process ends the operation process if all process is completed.

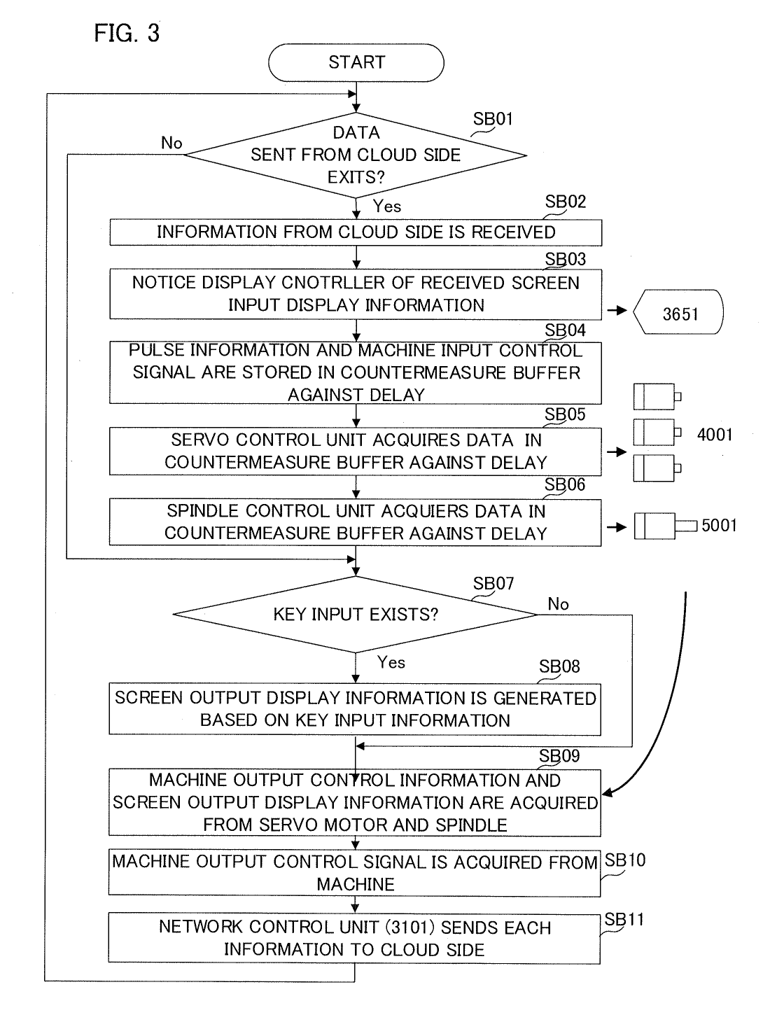

The operation control process on the machining tool No. 1 side according to the present embodiment will be described with the block diagram in FIG. 1 and the flowchart in FIG. 3.

The numerical control device 3001 on the machining tool No. 1 side will check the existence of the sent data from the control unit 2001 on the cloud side. The process proceeds to the key input checking process from the keyboard 3501 (Step SB07) if the sent data does not exist. The numerical control device 3001 receives the sent data (step SB02), and notices the display controller 3601 of the received screen input display information 2701, for displaying on the display device 3651 (Step SB03). Then the pulse information 2301 and the machine input control signal 2501 are stored in the countermeasure buffer 3201 against delay (Step SB04).

The servo control unit 3301 acquires information for servo control from the countermeasure buffer 3201 against delay and drives the spindle (Step SB06).

Next, it is determined whether key input exists or not in the key input checking process from the keyboard 3501 (Step SB07). If the key input exists, the screen output display information 3901 is generated based on information of the key input (Step SB08). If not, the process skips the process of Step SB08.

Following that, the machine output control information 3801 such as the servo delay amount, and the screen output display information 3901 such as the position feedback data and the servo/spindle load current value are acquired from the servo motor and the spindle (Step SB09), and the process proceeds to the next step. In the next step, the machine output control signal 3701 is acquired from the machine in the next step (Step SB10). The network control unit 3101 sends each kind of the generated or acquired information to the cloud side (Step SB11), and the process returns to Step SB01.

The embodiments according to the present invention are described above. It is noted that, the present invention is not limited to the examples of the embodiments described above and may be implemented in the other embodiments with changing the embodiments described above.

1. A numerical control system for controlling a plurality of machining tools by a host computer connected to the machining tools via communication line, having a host-computer-side numerical control device installed in the host computer and a machining-tool-side numerical control device installed in each machining tool, the host-computer-side numerical control device comprising:
a storage unit configured to store shared data for controlling the plurality of machining tools and machine unique data;
a control information generation unit configured to generate control information for controlling the plurality of machining tools; and
a host-computer-side network control unit configured to send the control information to the plurality of machining tools via the communication line and receive feedback information from the plurality of machining tools; and the machining-tool-side numerical control device comprising:
a shaft control unit configured to control a shaft of the machining tool based on the control information sent from the host computer;
a feedback information generation unit configured to generate the feedback information based on shaft control of the machining tool; and
a machining-tool-side network control unit configured to receive the control information from the host computer and send the feedback information to the host computer.

2. A numerical control system according to claim 1, wherein the host-computer-side numerical control device stores control software in a memory of the host-computer-side numerical control device, the host-computer-side numerical control device comprising:
a CNC control unit configured to generate pulse information to be included in the control information used for controlling the plurality of shafts of the machining tool;
a PMC control unit configured to generate machine input control signal used for the shaft control of the machining tool to be controlled; and
a display control unit configured to generate screen input display information used for displaying on a screen;
wherein the CNC control unit, the PMC control unit, the display control unit, the host-computer-side network control unit are included in the control software and a hardware installed in the host-computer-side numerical control device.

3. A numerical control system according to claim 1, wherein the machining-tool-side numerical control device further comprising:
a display unit configured to screen input display information in the control information sent from the host computer; and
an input device for manipulating the machining tool; wherein the shaft control unit; wherein
the shaft control unit is configured to control the shaft of the machining tool based on the pulse information in the control information and the machine input control signal and generate machine output control signal, machine output control information, and screen output display signal based on information generated by control of the machining tool and information from the input device.

4. A numerical control system according to claim 1, wherein the host-computer-tool-side numerical control device is configured to generate the control information for controlling the plurality of machining tools based on the feedback information and the shared data and the machine unique data, sent from the plurality of machining tools.

5. A numerical control system according to claim 1, wherein the machining-tool-side numerical control device further comprises a countermeasure buffer against delay, and the shaft control unit controls the machining tool based on the control information stored in the countermeasure buffer against delay.

6. A numerical control system according to claim 2, wherein the host-computer-tool-side numerical control device is configured to generate the control information for controlling the plurality of machining tools based on the feedback information and the shared data and the machine unique data, sent from the plurality of machining tools.

7. A numerical control system according to claim 3, wherein the machining-tool-side numerical control device further comprises a countermeasure buffer against delay, and the shaft control unit controls the machining tool based on the control information stored in the countermeasure buffer against delay.
